(19) United States
(12) Patent Application Publication
(10) Pub. No.: US 2002/0123950 A1
(43) Pub. Date: Sep. 5, 2002

(54) Method for estimating and displaying states representing varying probabilities of stock market strength

(76) Inventor: Russell Jared Koesterich, New York, NY (US)

Correspondence Address: FITZPATRICK CELLA HARPER & SCINTO, 30 ROCKEFELLER PLAZA, NEW YORK, NY, 10112, US

(21) Appl. No.: 09/795,127

(22) Filed: Mar. 1, 2001

(51) Int. Cl. G06F 17/60

(52) U.S. Cl. 705/36

(57) ABSTRACT

A method of quantifying the likelihood of a strong stock market is provided. A measure of market strength is defined. Based on an analysis of historical market data, a plurality of factors are defined, each factor having two levels, one of which is suggestive of the defined measure of market strength, and one of which is not. For each factor an odds ratio is computed. For each combination of the factor levels, defining a probability state, a probability of market strength is computed. Those probabilities of market strength may then be geometrically displayed in a multi-dimensional representation.

### BACKGROUND OF THE INVENTION

1. Field of the Invention

The present invention relates to a method for estimating and displaying states representing varying probabilities of stock market strength. The estimation is based on an analysis of historical market data over a number of predictive factors selected to indicate such strength.

2. Description of Related Art

Apparatuses for predicting the return of the stock market, or of specific stocks or groups of stocks, are well known. They range from a simple, mechanical stock trend indicator (see, for example, U.S. Pat. No. 3,984,657) to complex, computer-automated market prediction systems and displays (see, for example, U.S. Pat. No. 5,946,666 and PCT application WO 00/38094). The associated displays are generally directed to representing point estimates of return.

Those apparatuses, however, are not capable of estimating states representing varying probabilities of stock market strength, based on multiple predictive factors and an analysis of historical market data. Moreover, the displays of those apparatuses do not present information in such a way that allows an investor to visualize quickly and easily the relative likelihood of a strong market.

To satisfy the above need in the art, it is desirable that multiple probability states of market strength be estimated, based on an analysis of historical market data. This will provide investors with a more complete picture of risk and reward than can be conveyed with the relatively simplistic point estimates of return. It is further desirable that these probability states be displayed in such a way that permits a quick understanding of the predicted market strength, and to provide an easy means for comparing the current state of market data to the displayed historical-based probability states.

### SUMMARY OF THE INVENTION

To overcome the above-described limitations in the art, the present invention relates to a method that, in various embodiments, estimates probability states of stock market strength based on an analysis of historical market data over various predictive factors. The present invention further provides investors with a multi-dimensional representation of those probability states.

In one aspect of the present invention, a method of estimating the likelihood of a strong stock market is provided. This method may include the steps of:

(1) defining a measure of market strength;

(2) based on an analysis of historical market data, defining a plurality of factors, each factor having two levels, one of which is suggestive of the defined measure of market strength, and one of which is not;

(3) for each factor, computing an odds ratio, (preferably using a multi-variable binary logistic regression technique); and

(4) for each combination (defined as a probability state) of the factor levels, computing a probability of market strength from the odds ratio.

In another aspect of the present invention, a method of displaying the probability states is provided. For example, the probability states may be mapped to a multi-dimensional image, where each probability state may be represented geometrically with varying color and/or intensity that reflects its corresponding probability of market strength.

In still another aspect of the present invention, rather than, or in addition to, the probability of market strength computation, the average return over a predefined time period may be computed for each probability state. The average returns may also be graphically displayed in like manner as the probabilities of market strength.

In still another aspect of the present invention, rather than, or in addition to, the probability of market strength computation or the average return computation, the number of historical time periods evidencing each probability state may be computed.

In still another aspect of the present invention, the probability state reflecting current market data may be computed. That probability state may be graphically displayed in a contrasting color to readily identify it.

Preferably, the market strength measure is defined as a return in excess of the 12-month historical median of a specified percentage (for example, 11.90%).

Preferably, three factors are used in the estimation process, each having two levels, resulting in eight probability states and a three-dimensional display thereof. More preferably, these factors include the dollar rising against the yen on a year-over-year basis; the market's P/E ratio contracting by at least a specified percentage (for example, 12.50%) on a year-over-year basis; and long term yields falling a specified number of basis points (“bps,” for example, 50 bps) over a specified time interval (for example, six months). Still more preferably, the probability states are displayed as a large cube formed of eight smaller octants, one for each probability state. Various colors and intensities may be used in each of the smaller octants to indicate predicted market strength (or average return).

### BRIEF DESCRIPTION OF THE DRAWINGS

FIG. 1 is a table displaying regression results.

FIG. 2 is a table displaying eight probability states of market strength.

FIG. 3 is a graphical representation of eight probability states of market strength expressed as a cube.

FIG. 4 is a cut-away view of FIG. 3, showing probability state 8 hidden in FIG. 3.

### DESCRIPTION OF THE PREFERRED EMBODIMENTS

One method of the present invention uses a three-factor, eight-state model for deriving the probability (likelihood) that the market will be strong over the next twelve months.

A measure of strong stock market is first defined. The preferred method uses the index recording a market return above a specific percentage, preferably 11.90%, the median 12-month return since 1973. Of course, one skilled in the art will appreciate that any other measure of a strong stock market may be used instead.

In view of this measure, in the next step of the method, three factors are selected and defined. Based on an analysis of historical market data, three general factors have been selected that are deemed to accurately predict market strength as defined above. They relate to the change in dollar-yen rate, the expansion/contraction of the market's P/E (price/earnings) ratio, and the change in yield on the 10-year Treasury note. One skilled in the art will readily appreciate that other factors may be defined and selected, and that any number of factors, for example, two or four or more, may be used.

In particular, based on an analysis of historical market data from 1973 forward (1973 being the date of inception of the dollar-yen series), in view of the above-defined measure of market strength, these factors were specifically defined as follows:

first factor: dollar rising against the yen on a year-over-year basis;

second factor: the market's P/E ratio contracting by 12.50% or more on a year-over-year basis; and

third factor: long-term yield drop (of 10-year Treasury notes) of 50 bps or more over six months.

It is preferable to use these three factors because each of them has a high degree of statistical significance with respect to the defined strength measure.

For example, when the dollar value rises versus the yen on a year-over-year basis, the market (S&P 500 index) has recorded returns in excess of 11.90% over the next twelve months (the strength measure) 67.7% of the time. In contrast, when the dollar value decreases versus the yen on a year-over-year basis, the S&P 500 index has managed to eclipse the median return of 11.90% over the next twelve months (i.e., the market strength measure) just 41.0% of the time.

Similarly, when the market's P/E ratio contracts by 12.50% or more over the year, representing the 25% lowest annual changes (ranging from −12.50% to −49.86%), the S&P 500 index has beaten the median return of 11.90% over the next twelve months (the market strength measure) 69.3% of the time. In contrast, when the market's P/E ratio has contracted by less than 12.50% or has expanded (ranging from −12.44% to +76.38%), representing the remaining 75% of observations, the S&P 500 index has beaten the median return of 11.90% over the next twelve months (the market strength measure) just 43.3% of the time.

Lastly, when long term yields have fallen 50 or more basis points over six months (25% of all observations), the S&P 500 index has exceeded the median return of 11.90% over the next twelve months (the market strength measure) 68.1% of the time. In contrast, when long term yields have fallen less than the 50 basis point threshold or have risen (75% of all observations), the S&P 500 index has exceeded the median return of 11.90% over the next twelve months just 42.8% of the time.

Thus, each factor used to predict market strength results in two levels, i.e., one that is suggestive of a strong market and one that is not. That is, each factor is binary. In particular, the dollar-yen year-over-year (“y/y”) “up” possibility resulted in a strong market 67.7% of the time, and the “down” possibility resulted in a weak market only 59% of the time. The possibility of the market P/E contracting 12.5% or more resulted in a strong market 69.3 of the time, while the possibility associated with a market P/E contraction of less than 12.5%, or an expansion, resulted in a weak market 56.7% of the time. The possibility of long term (“LT”) yields falling 50 bps or more resulted in a strong market 68.1% of the time, while the possibility of the yields falling less than 50 bps, or rising, resulted in a weak market 57.2% of the time. One skilled in the art will appreciate that other factors may be used in combination with, or in place of, any of the factors described above, so long as that factor is binary, that is, has one level that is suggestive of a strong market and one level that is not.

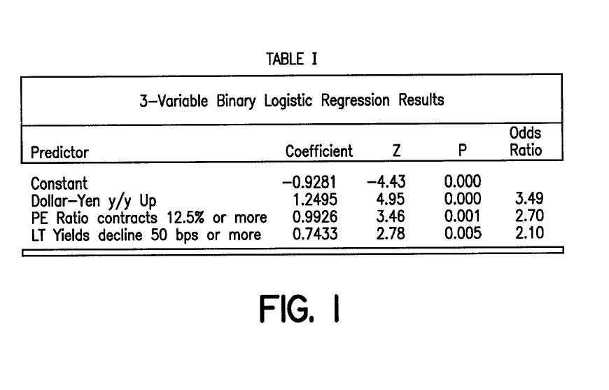

The next step is to compute an odds ratio for each factor to further quantify the relationship between the favorable state (for example, dollar-yen y/y up) and the desired outcome, or success. Again, success is defined by the market strength measure, i.e., a twelve-month forward return of greater than 11.90%. Preferably, the odds ratio is computed using binary logistic regression, a well-known statistical technique. The results of the regression analysis are shown in FIG. 1.

The first factor, the dollar-yen rate up year-over-year, has an odds ratio of 3.49. This means that the odds of the market being strong over the next year are 3.49 times greater when the dollar-yen is up versus the other possibility, i.e., when the dollar-yen is down.

The second factor, a contraction in the market's P/E ratio of 12.5% or more, has an odds ratio of 2.70. This indicates that the odds of the market recording a return in excess of 11.90% over the next year is 2.70 times greater as opposed to when the market P/E had contracted slightly or expanded.

Finally, the third factor, a six-month decline in long term bond yields of 50 basis points or more, has an odds ratio of 2.10. Thus, the likelihood of the market being strong over the next year is 2.10 times greater when yields have fallen by this magnitude than when yields have fallen by a lesser amount or have risen.

As a general rule, odds ratios between 0.6 and 1.4 are insignificant. Thus, odds ratios larger than 1.4, such as the odds ratios computed for the three factors above, are very significant, which means that the factors are good predictors of a strong stock market.

Other fields in the table of regression results further support the notion that the three selected factors are good predictors of market strength. The z-statistics are high and the p-values are very low. In addition, consistent with the odds ratios, the coefficients provide an idea of the relative importance of each factor in predicting market strength, with the highest coefficient being the most important. Thus, dollar-yen y/y up appears to have a more significant impact on the market's ability to record strong returns than the contraction in the P/E ratio of 12.5% or more, or than a 50 bps or more drop in long term yields.

The next step in the method of the present invention is to calculate the probabilities associated with these predictive factors by using the odds ratios. The probabilities are calculated from the odds ratios using well-known statistical techniques. Because there are three factors, each with two levels, there is a total of eight (2×2×2=8) probability states.

For example, state 1 is the combination of each factor possibility predictive of a strong market:

(1) dollar-yen y/y up;

(2) P/E ratio y/y contracting 12.5% or more; and

(3) decline of 50 bps or more in long term yields over six months.

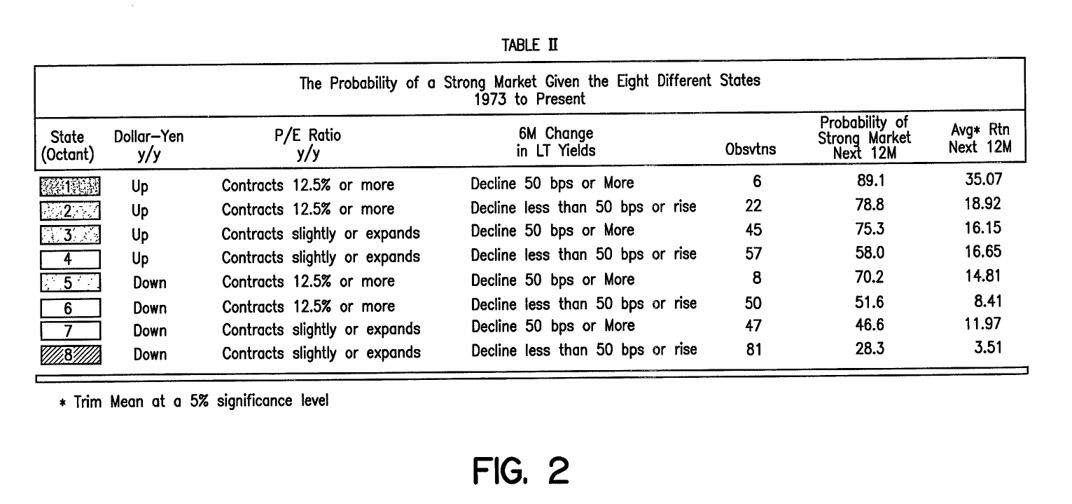

For state 1, the probability of a strong market over the next 12 months is 89.1%, the highest probability on the list, as would be expected. The remaining seven probability states, and their associated market strength probabilities, are listed in FIG. 2.

The table of FIG. 2 lists the number of times each state was observed in the analysis of the historical market data. For example, state 1 were observed six times since 1973.

The table of FIG. 2 also lists, for each probability state, the average 12 month return. For example, the average 12 month return for state 1 is 35.07%, clearly much higher than the strong market return measure of 11.90%.

Certain general observations may be made. In state 1, there were six periods in which all three factors were in the supportive position, i.e., supportive of a strong market. The probability that the market would return in excess of the median return was 89.1%. During these periods, a powerful bull market developed, recording an average investment return of 35.07% over the next year. These periods have been rare and have only occurred in February to March 1982, July 1982, and November to December 1984.

In contrast, in state 8, there were 81 periods in which none of the three factors supported a median return of 11.90% or more, i.e., none of which indicated a strong market. In this state, the probability of a strong market was 28.3%. During these periods, the market returned just 3.51% over the next year.

More recently, in August 2000, dollar-yen values continued to languish in a nine-month old trading range between 102-110, and were down more than 4% from year ago levels. In terms of the market's P/E ratio, at July 2000's closing price of 1465, the S&P 500 index was trading at 28.74 times trailing earnings. At the end of July 1999, the index was trading at 34.62 times earnings. Therefore, on a year-over-year basis, the index's P/E ratio has contracted 17.0%. Long term bond yields averaged 6.04% in July, a 61 basis point drop from January 2000's levels.

The analysis of market data for August 2000, thus results in state 5. That is, the dollar-yen y/y value was down, the market's P/E ratio had contracted more than 12.5% year-over-year, and long term yields had fallen more than 50 basis points over the past six months. Accordingly, based on the data of FIG. 2, in August 2000 the probability of a strong market over the next twelve months was 70.2% and the expected, average 12 month return was 14.81%.

More recently, the probability that the market will be strong has shifted even higher. In particular, an analysis of market data as of October 2000 resulted in a shift from state 5 (August 2000) to state 2, as both the long term yield and dollar-yen factors switched states. That is, long term yields had fallen over the previous six months by less than the 50 basis points. In addition, the year-over-year change in the dollar-yen exchange rate went from “down” to “up” as the average exchange increased by 2.31% from October 1999. The market's P/E ratio remained the same. Thus, the probability of a strong market occurring had improved from 70.2% (state 5) to 78.8% (state 2), and the expected return over 12 months increased from 14.81% (state 5) to 18.92% (state 2), as shown in FIG. 2.

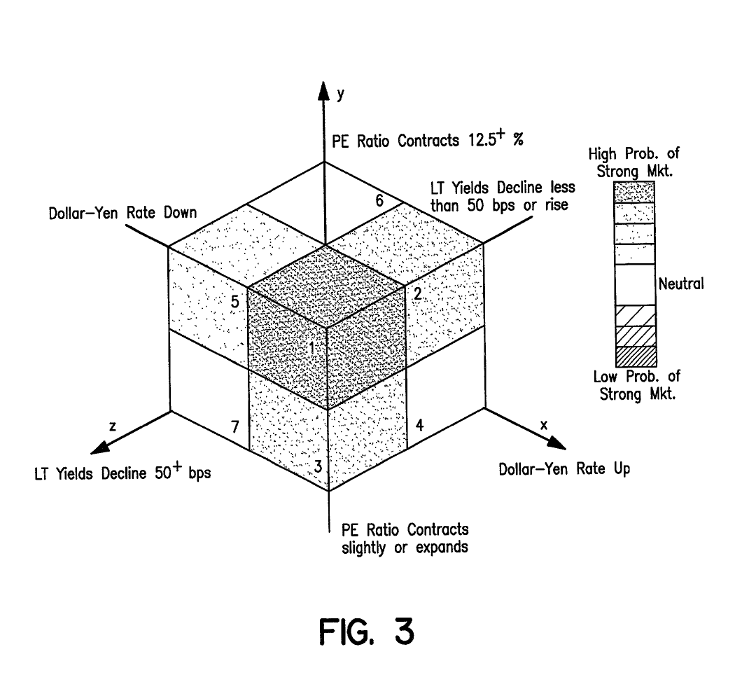

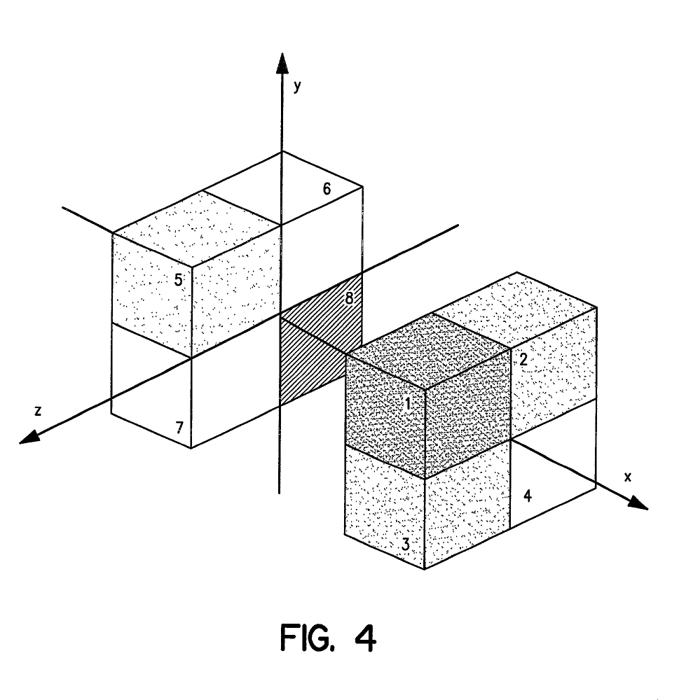

In another embodiment of the present invention, the results of the analysis are graphically displayed in three-dimensional form. FIG. 3 is a graphical representation of the probability states, in the form of a cube. As best shown in FIG. 4, the cube is made of eight smaller cubes or “octants,” each of which corresponds to a probability state listed in FIG. 2.

In descending order of probability of a strong market, based on the results shown in FIG. 2, the probability states/octants are 1, 2, 3, 5, 4, 6, 7, 8. These may be represented on the cube by decreasing intensity, by different colors, or a combination of both, so as to allow the viewer to easily and quickly perceive the likelihood of a strong market. For example, blue may be used to represent states of high (70% or more) probability. State 1 may be represented by a dark blue octant, in which all axes (x, y, z) are positive and the probability of a strong market is the highest. States 2, 3 and 5 may be respectively represented by blue octants of decreasing intensity. Even paler, or white octants, may be used to represent states of lower, neutral probabilities. In FIG. 4, the white octants correspond to neutral probabilities, between 40-59%, of states 4, 6, and 7, when the position of the three factors provides less conclusive evidence that the event, a strong market, will occur. State 8, with negative x, y and z values, in which the probability of a strong market is only 28.3%, may be represented by an octant of contrasting color, such as orange.

Further, the state corresponding to current market conditions can be readily shown in the cube, for example, by using a different color in the octant corresponding to that state. Continuing the examples set forth above, in August 2000 octant 5, corresponding to that month's market conditions, would be shown in yellow. In October 2000, octant 5 would be returned to its light blue color, while octant 2, corresponding to October 2000 market conditions, would be changed to yellow. This permits quick visualization of the current state in comparison to other, historical states. As would be appreciated by one skilled in the art, other variations of displaying the current, the prior month's and historical probability states may be accomplished.

While the present invention has been described in detail with reference to the preferred embodiments thereof, many modifications and variations of the present invention will be readily apparent to one skilled in the art. Accordingly, the scope of the invention should not to be limited by the details of the preferred embodiments described above, but only by the terms of the appended claims.

What is claimed is:

1. A method comprising the steps of:
defining a measure of market strength;
based on an analysis of historical market data, defining a plurality of factors, each factor having two levels, one of which is suggestive of the defined measure of market strength, and one of which is not;
for each factor, computing an odds ratio; and
for each combination of the factor levels, computing a probability of market strength from the odds ratio.

2. A method according to claim 1, further comprising the step of displaying each combination in a multi-dimensional representation.

3. A method according to claim 2, where each combination is represented geometrically, and with a particular color or intensity so as to reflect the corresponding probability of market strength.

4. A method according to claim 1, wherein the market strength measure is defined as a return in excess of the 12-month historical median of a specified percentage.

5. A method according to claim 1, wherein three factors are used, resulting in eight combinations and a three-dimensional display thereof.

6. A method according to claim 1, wherein the factors comprise:
the dollar rising against the yen on a year-over-year basis;
the market's P/E ratio contracting by at least a specified percentage on a year-over-year basis; and
long term yields falling a specified number of basis points over a specified time interval.

7. A method according to claim 1, wherein each odds ratio is computed using binary logistic regression.

8. A method according to claim 1, wherein an average return over a predefined time period is computed for each probability state.

9. A method according to claim 8, further comprising the step of displaying the average return of each combination.

10. A method according to claim 1, a number of historical time periods evidencing each combination is computed.

11. A method according to claim 1, wherein a combination reflecting current market data is computed.

12. A method according to claim 3, wherein a combination reflecting current market data is computed and is displayed in a color different than colors corresponding to other displayed combinations.

13. A method according to claim 5, further comprising the step of displaying the eight combinations as a cube formed of eight octants, one octant corresponding to each combination.

14. A method according to claim 13, where each octant is displayed with a particular color or intensity so as to reflect the corresponding probability of market strength.

15. A method comprising the steps of:
defining a measure of market strength;
based on an analysis of historical market data, defining a plurality of factors, each factor having two levels, one of which is suggestive of the defined measure of market strength, and one of which is not; and
for each combination of the factor levels, computing an average return over a predefined time period.

16. A method comprising the steps of:
defining a measure of market strength;
based on an analysis of historical market data, defining a plurality of factors, each factor having two levels, one of which is suggestive of the defined measure of market strength, and one of which is not; and
for each combination of the factor levels, computing a number of historical time periods evidencing each combination.
